(19) United States
(12) Patent Application Publication
(10) Pub. No.: US 2026/0160999 A1
(43) Pub. Date: Jun. 11, 2026

(54) INCOUPLER CONFIGURED FOR INCREASED WORKING DISTANCE COMPENSATION

(71) Applicant: GOOGLE LLC, Mountain View, CA (US)

(72) Inventor: Thomas Hoekman, Redwood City, CA (US)

(21) Appl. No.: 18/972,226

(22) Filed: Dec. 6, 2024

(51) Int. Cl. G02B 27/01

(52) U.S. Cl. CPC G02B 27/0172

(57) ABSTRACT

A lightguide includes an incoupler configured to compensate for an increased working distance. This incoupler has a semi-circular shape that includes a planar surface and an opposite non-planar surface. Additionally, the incoupler has a diameter that is greater than the exit pupil formed by light emitted by a light engine. Further, to compensate for an increased working distance, the incoupler is arranged such that the light emitted from the light engine is received at the non-planar surface of the incoupler and exits the planar surface of the incoupler. After this light exits the planar surface of the incoupler, the light propagates through the body of the lightguide and arrives at an outcoupler. This outcoupler then directs the light out of the lightguide and toward a user.

### BACKGROUND

Certain head-wearable displays (HWDs) and other near-eye displays (NEDs) are configured to present images to a user such that the images are viewable in a real-world space visible through the HWD. To present such images to the user, these HWDs direct light beams emitted from a projector to the user by using a lightguide that includes an incoupler and an outcoupler. This incoupler of a lightguide is configured to direct light emitted from a projector into the main body of the lightguide within which the light beams propagate by total internal reflection (TIR). The light beams then propagate through the lightguide until they are received at the outcoupler which directs the light beams out of the lightguide and toward the user such that images are presented to the user. For example, the images are presented to a user in a field of view (FOV) that is based on the characteristics of the lightguide.

### BRIEF DESCRIPTION OF THE DRAWINGS

The present disclosure may be better understood, and its numerous features and advantages are made apparent to those skilled in the art by referencing the accompanying drawings. The use of the same reference symbols in different drawings indicates similar or identical items.

FIG. 1 is a diagram of an example display system including a lightguide assembly with an incoupler configured for increased working distance compensation, in accordance with some embodiments.

FIG. 2 is a diagram of a projection system that projects images directly onto the eye of a user via display light, in accordance with some embodiments.

FIG. 3 is a diagram of an example incoupler configured for increased working distance compensation, in accordance with some embodiments.

FIG. 4 is a diagram of an example lightguide including an incoupler configured for increased working distance compensation, in accordance with some embodiments.

### DETAILED DESCRIPTION

Some NEDS (e.g., augmented reality head-worn displays) are designed with an eyeglass form factor including at least one lens containing a lightguide to direct light to a user's eye. These NEDS, for example, generally have a frame designed to be worn in front of a user's eyes to allow the user to view both their environment and computer-generated content projected from the combiner. Components that are necessary to the functioning of these NEDs, such as, for example, an optical engine to project computer-generated content (e.g., display light representative of one or more images), cameras to pinpoint physical location, cameras to track the movement of the user's eye(s), processors to power the optical engine, and a power supply, are typically housed within the frame of the NEDS. As the frame for an NED has limited volume in which to accommodate these components, it is desirable that these components be as small as possible and configured to interact with the other components in very small volumes of space.

To guide light to a user's eye, some NEDs include a light engine configured to emit display light representing an image toward an incoupler of a lightguide. For example, the light engine emits lights such that the light forms an exit pupil representative of the image at or near an output of the light engine. This exit pupil, for example, has a circular shape with a diameter based on the settings, optics, or both of the light engine. From the light engine, the light is then received by an incoupler of the lightguide. The distance the light travels from the formed exit pupil to the incoupler of the lightguide is referred to herein as the “working distance” of the lightguide. Further, the incoupler, for example, includes one or more diffractive gratings (e.g., structures configured to diffract light), reflective facets (e.g., structures configured to reflect light), or both that provide the received light to a main body of the lightguide such that the light propagates through the main body of the lightguide using total internal reflection (TIR), partial internal reflection (PIR), or both until the light is received at an outcoupler of the lightguide. The outcoupler, for example, includes one or more diffractive gratings, reflective facets, or both that direct the light out of the lightguide and toward the eye of the user. As the light is directed out of the lightguide, the light forms one or more outcoupled exit pupils a distance away from the lightguide that allow the user to view the image represented by the emitted light within an FOV of the NED. The range of different user eye positions from which the user will be able to see the image within the FOV is referred to herein as an “eyebox” of the image. To enlarge this eyebox, the lightguides of some NEDs further include an exit pupil expander (EPE) disposed between the incoupler and the outcoupler of the lightguide. As the EPE receives the light propagating within the lightguide, diffractive gratings, reflective facets, or both of the EPE split the light into one or more beams in one or more directions and direct these split beams to the outcoupler. Due to the EPE splitting the light, additional exit pupils are formed, allowing additional user eye positions to view the image represented by the light and expanding the eyebox of the image.

However, certain design considerations, such as aesthetics, reliability, form factor, ease of assembly, tolerances, and the like, increase the working distance of the lightguide such that the light travels a greater distance from the exit pupil formed by the light engine to the incoupler. Due to the light traveling this greater distance, a pupil walk occurs between the formed exit pupil and the incoupler which increases the likelihood that the exit pupil is misaligned with the incoupler. Such misalignment between the exit pupil and the incoupler causes vignetting in the image presented to the user which affects the FOV of the presented image. For example, because of the vignetting, there is an increased likelihood that one or more edges of the FOV are dimmed or darkened. As such, to help mitigate this vignetting, systems and techniques disclosed herein are directed to a lightguide including an incoupler configured for increased working distance compensation. Such an incoupler, for example, includes a shape having a first surface and a second non-planar surface opposite the first surface. As an example, the incoupler forms a D-shape having a planar surface disposed nearest the body of a lightguide and a non-planar surface opposite the planar surfaces surface and disposed nearest the light engine. Further, the incoupler has an increased size when compared to incouplers not configured for increased working distance compensation. For example, the incoupler includes a diameter greater than the diameter of the exit pupil formed by the light engine. Due to the shape and increased size of the incoupler, the exit pupil formed by the light engine is less likely to be misaligned with the incoupler due to any pupil walk which reduces the likelihood of vignetting. Additionally, the shape and increased size of the incoupler help reduce the likelihood of ghost images (e.g., ghosting) being introduced in the presented FOV due to stray light within the lightguide.

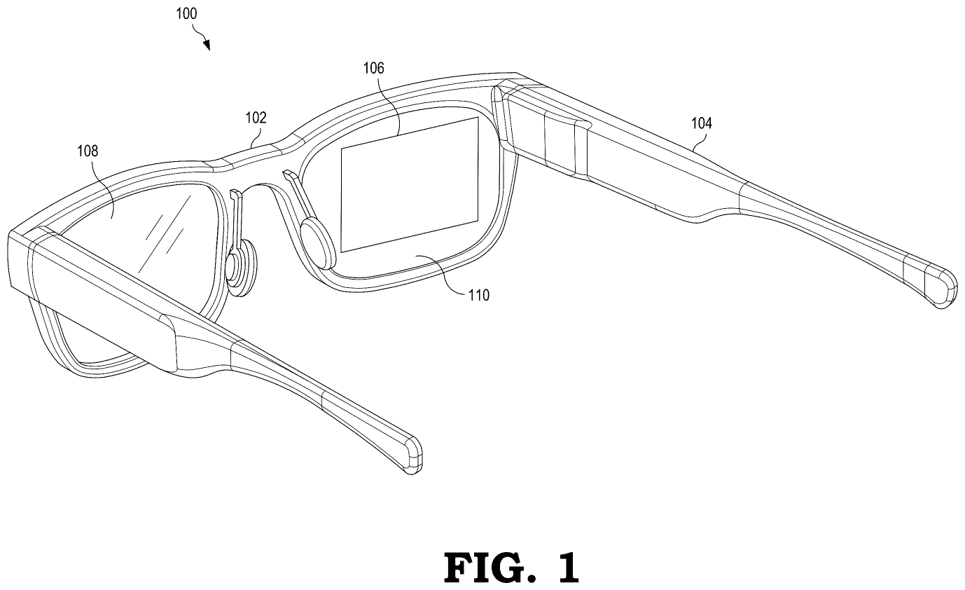

FIG. 1 illustrates an example display system 100 having a support structure 102 that includes an arm 104, which houses a projection system configured to project display light representative of images toward the eye of a user, such that the user perceives the images as being displayed in an FOV area 106 of a display at one or both of lens elements 108, 110. In the depicted embodiment, the display system 100 is an HWD or other NED that includes a support structure 102 configured to be worn on the head of a user and has a general shape and appearance of an eyeglasses frame or sunglasses frame. The support structure 102 contains or otherwise includes various components to facilitate the projection of such images toward the eye of the user, such as a projector (e.g., optical engine) and a lightguide. In some embodiments, the support structure 102 further includes various sensors, such as one or more front-facing cameras, rear-facing cameras, other light sensors, motion sensors, accelerometers, and the like. The support structure 102 further can include one or more radio frequency (RF) interfaces or other wireless interfaces, such as a Bluetooth interface, a Wi-Fi interface, and the like. Further, in some embodiments, the support structure 102 includes one or more batteries or other portable power sources for supplying power to the electrical components of the display system 100. In some embodiments, some or all of these components of the display system 100 are fully or partially contained within an inner volume of support structure 102, such as within the arm 104 in a region of the support structure 102. It should be noted that while an example form factor is depicted, it will be appreciated that in other embodiments the display system 100 may have a different shape and appearance from the eyeglasses frame depicted in FIG. 1.

One or both of the lens elements 108, 110 are used by the display system 100 to provide an extended reality (XR) display in which rendered graphical content can be superimposed over or otherwise provided in conjunction with a real-world view as perceived by the user through the lens elements 108, 110. For example, display light used to form a perceptible image or series of images may be projected (e.g., emitted) by a projector of the display system 100 onto the eye of the user via a series of optical elements, such as a lightguide formed at least partially in the corresponding lens element. One or both of the lens elements 108, 110 thus include at least a portion of a lightguide that routes display light received by an incoupler of the lightguide to an outcoupler of the lightguide which is configured to direct the display light out of the lightguide and toward an eye of a user of the display system 100. Such display light is modulated onto the eye of the user such that the user is able to view the image represented by the display light within a FOV of the display system 100. For example, the light engine first emits display light representative of an image such that the display light forms an exit pupil near (e.g., 1 MM or less) or at the output of the light engine. This exit pupil, for example, includes a shape (e.g., circle) and a size (e.g., diameter) based on the configuration of the light engine. The display light then travels from the point at which the exit pupil was formed to the incoupler of the lightguide. That is, the light travels across the working distance of the lightguide and is received by the incoupler of the lightguide.

Such a lightguide, for example, includes a shape having a first surface disposed nearest to the body of the lightguide and a second, non-planar surface disposed nearest to the light engine. This first surface, for example, includes a planar surface or a non-planar surface having a curvature, as an example, with a radius greater than or equal to 2.5. Further, according to embodiments, the incoupler forms a D-shape with the first surface of the D-shape facing the body of the lightguide and the non-planar surface of the D-shape facing the light engine. This D-shape, as an example, also includes one or more curved corners. In some embodiments, the incoupler forms a shape having an axis of symmetry disposed near (e.g., within +/−10 degrees) of a k-vector (e.g., grating k-vector) of the incoupler (e.g., the vector along which light exits the incoupler). Additionally, the incoupler has a size (e.g., diameter) greater than the exit pupil formed by the light engine. For example, the incoupler has a diameter equal to or greater than 4.5 mm.

After receiving the display light, the incoupler is configured to direct the display light into the body of the lightguide such that the display light propagates through the lightguide via PIR, TIR, or both. As an example, in some embodiments, the incoupler includes a telecentric structure configured to direct display light into the lightguide such that the display light is collimated and such that the display light propagates through the lightguide via PIR, TIR, or both. While propagating through the lightguide, the display light is then received by an outcoupler which directs the display light out of the lightguide and toward the eye of a user which enables the user to see the image represented by the display light. In embodiments, each of the lens elements 108, 110 is sufficiently transparent to allow a user to see through the lens elements to provide an FOV area 106 of the user's real-world environment such that the image appears superimposed over at least a portion of the real-world environment. Due to the size and shape of the incoupler, the likelihood of vignetting due to any increased working distance is decreased. For example, due to the size and shape of the incoupler, the incoupler receives a greater portion of the exit pupil for display light associated with regions of a resulting FOV (e.g., field points) likely to experience vignetting due to a pupil walk away from one or more components (e.g., EPE, body) of the lightguide. Because the incoupler receives a greater portion of the exit pupil of display light corresponding to these field points, the likelihood of vignetting at these field points of the FOV of a presented image is reduced. That is to say, due to the size and shape of the incoupler, the incoupler captures more power from display light associated with regions of a resulting FOV (e.g., field points) likely to experience vignetting which decreases the likelihood of such vignetting.

In some embodiments, the light engine is a digital light processing-based projector, a micro-projector, a scanning laser projector, or any combination of a modulative light source such as a laser or one or more LEDs and a dynamic reflector mechanism such as one or more dynamic scanners or digital light processors. In some embodiments, the projector includes multiple laser diodes (e.g., a red laser diode, a green laser diode, and/or a blue laser diode). The light engine is communicatively coupled to the controller and a non-transitory processor-readable storage medium or a memory that stores processor-executable instructions and other data that, when executed by the controller, cause the controller to control the operation of the light engine.

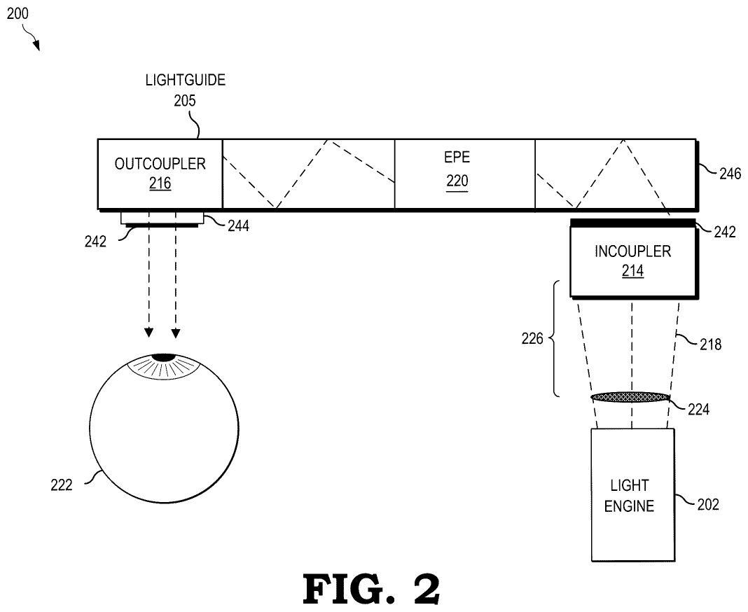

FIG. 2 illustrates a simplified block diagram of a projection system 200 that projects images directly onto the eye of a user via display light. The projection system 200 includes a light engine 202 and a lightguide 205. The term “lightguide,” as used herein, will be understood to mean a combiner using one or more of TIR, PIR, specialized filters, diffractive structures, and/or reflective surfaces, to transfer light from an incoupler (e.g., incoupler 214) to an outcoupler 216. In some display applications, the light is a collimated image, and the lightguide transfers and replicates the collimated image to the eye. In some embodiments, the projection system 200 is implemented in a HWD, NED, or other display system, such as the display system 100 of FIG. 1.

The light engine 202 includes one or more display light sources configured to generate and output display light 218 (e.g., visible display light such as red, blue, and green display light and/or non-visible display light such as infrared display light) representing an image. In some embodiments, the light engine 202 is coupled to a driver or other controller (not shown), which controls the timing of emission of display light from the display light sources of the light engine 202 in accordance with instructions received by the controller or driver from a computer processor coupled thereto to modulate the display light 218 to be perceived as images when output to the retina of an eye 222 of a user. For example, during the operation of the projection system 200, multiple display light beams having respectively different wavelengths are output by the display light sources of the light engine 202, then combined via a beam combiner (not shown), before being directed to the eye 222 of the user. The light engine 202 modulates the respective intensities of the display light beams so that the combined display light reflects a series of pixels of an image, with the particular intensity of each display light beam at any given point in time contributing to the amount of corresponding color content and brightness in the pixel being represented by the combined display light at that time. According to embodiments, the light engine 202 is configured to emit display light 218 such that display light 218 forms an exit pupil 224 near or at the output of the light engine 202. As an example, the light engine 202 forms an exit pupil 224 less than 1 mm from the output of the light engine 202. Such an exit pupil 224, for example, includes a shape (e.g., circular shape), and size (e.g., diameter) based on the configuration of the light engine 202. As an example, the exit pupil 224 has a circular shape with a diameter of 4 mm. After forming the exit pupil 224, display light 218 travels to the lightguide 205 which includes or is otherwise connected to the incoupler 214, EPE 220, and outcoupler 216. For example, display light 218 travels a working distance 226 which represents the distance between the point where the exit pupil 224 was formed and the incoupler 214 before being received by the incoupler 214 included in or otherwise connected to the lightguide 205.

In embodiments, the incoupler 214 is configured to compensate for the working distance 226 display light 218 travels before being received at the incoupler 214. To this end, incoupler 214 includes a shape having a first surface (e.g., planar surface, curved surface) disposed adjacent to the body 246 of the lightguide 205 and a second non-planar surface (e.g., curved surface) disposed nearest to the light engine 202. As an example, the incoupler 214 includes a D-shape with the second non-planar surface of the D-shape facing the light engine 202 and the first surface of the D-shape facing the body 246 of the lightguide 205. Further, the incoupler 214 includes a size (e.g., diameter) larger than the exit pupil 224. For example, the incoupler 214 includes a diameter equal to or greater than 4.5 mm when an exit pupil of display light 218 has a diameter of 4 mm. According to some embodiments, the incoupler 214 includes a diameter determined based on the following inequality:

$${D}_{ic} \geq {D}_{xp} * tan ( \frac{FOV}{2} ) * WD \qquad [ EQ01 ]$$

wherein D_{ic} represents the diameter of the incoupler 214, Dₓₚ represents the diameter of the exit pupil 224, FOV represents a resulting FOV (e.g., in degrees), and WD represents the working distance 226. Additionally, in some embodiments, incoupler 214 includes or is otherwise connected to one or more polarization films 242 configured to linearly or circularly polarize display light 218 so as to help reduce ghosting in an image displayed to the eye 222 of the user, improve the uniformity of an image presented to a user, or both. For example, incoupler 214 includes polarization film 242 disposed on the first surface of the incoupler 214 and configured to linearly or circularly polarize display light 218 directed by the incoupler 214. Though the example embodiment presented in FIG. 2 shows one polarization film 242 disposed on incoupler 214, in other embodiments, any non-zero integer number of polarization films 242 may be disposed on or near one or more surfaces of the incoupler 214.

In response to receiving display light 218 (e.g., in response to receiving the exit pupil 224 after any pupil walk from the working distance 226), the incoupler 214 is configured to direct display light 218 into the body 246 of the lightguide 205. To this end, the incoupler 214 includes one or more diffractive gratings, reflective facets, or both configured to reflect and direct display light (e.g., display light 218) into the lightguide 205. These diffractive gratings, for example, include one or more diffractive grating structures disposed on or within the incoupler 214 configured to diffract received light such as Bragg grating structures, surface-relief grating structures, polarization volume grating structures, volumetric holographic grating structures, and the like. Additionally, reflective facets, for example, include one or more structures disposed on or within the incoupler 214 that have one or more reflective surfaces, reflective coatings, mirrors (e.g., dielectric mirrors, metallic mirrors, Bragg facets), mirror coatings, or any combination thereof. According to embodiments, the incoupler 214 is configured to provide the display light 218 to the body 246 of the lightguide 205 such that the display light 218 propagates through lightguide 205 via PIR, TIR, or both until the display light 218 is received by the EPE 220. This EPE 220 includes one or more diffractive grating structures (e.g., Bragg grating structures, surface-relief grating structures, polarization volume grating structures, volumetric holographic grating structures), reflective structures (e.g., reflective surfaces, reflective coatings, mirrors, mirror coatings), or both configured to increase the eyebox of a presented image by increasing the number of exit pupil output by the lightguide 205. For example, the EPE 220 is configured to split display light 218 into two or more beams that each form corresponding exit pupils which increases the size of a resulting eyebox for the image. From the EPE 220, the display light 218 propagates through a second portion of the body 236 of the lightguide 205 via TIR, PIR, or both until the display light 218 is received by the outcoupler 216. This outcoupler 216, for example, includes one or more diffractive grating structures (e.g., Bragg grating structures, surface-relief grating structures, polarization volume grating structures, volumetric holographic grating structures), reflective structures (e.g., reflective surfaces, reflective coatings, mirrors, mirror coatings), or both configured to direct the display light 218 out of the lightguide 205 and toward the eye 222 of a user. For example, the outcoupler 216 directs the beams generated by the EPE 220 toward the eye 222 of a user so as to form multiple exit pupils.

According to embodiments, although not shown in the example of FIG. 2, in some embodiments additional optical components are included in any of the optical paths between the light engine 202 and the incoupler 214, between the incoupler 214 and the EPE 220, between the EPE 220 and the outcoupler 216, between the outcoupler 216 and the eye 222 (e.g., in order to shape the display light for viewing by the eye 222 of the user), or any combination thereof. As an example, in embodiments, the outcoupler 216 includes or is otherwise connected to one or more polarization films 242 configured to linearly or circularly polarize the display light 218 directed by the outcoupler 216. As an example, a polarization film 242 configured to linearly or circularly polarize display light 218 is disposed on a surface of outcoupler 216. Though the example embodiment presented in FIG. 2 shows outcoupler 216 as including or being connected to one polarization film 242, in other embodiments, outcoupler 216 can include or be connected to any non-zero integer number of polarization films. Further, in some embodiments, the lightguide 205 includes a turning prism 244 configured to change the direction of the image presented by display light 218. Though the example embodiment presented in FIG. 2 shows the lightguide 205 as including a single turning prism 244 disposed between the outcoupler 216 and the eye 222 of a user, in other embodiments, the lightguide 205 can include any non-zero integer number of turning prisms 244 disposed before or after any component of the lightguide 205.

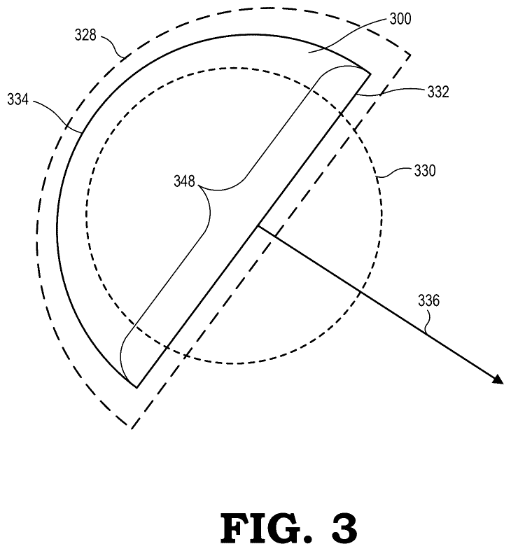

Referring now to FIG. 3, an example incoupler 300 configured for increased working distance compensation is presented, in accordance with embodiments. In embodiments, example incoupler 300 is implemented within the lightguide 205 as, for example, the incoupler 214. Example incoupler 300 includes a shape forming a semi-circle or D-shape. For example, example incoupler 300 includes a first surface 332 and an opposite second, non-planar (e.g., curved) surface 334. In embodiments, the first surface 332 includes a planar surface or a curved surface (e.g., radius greater than 2.5 mm) and is disposed nearest the body 246 of the lightguide 205 and the second, non-planar surface 334 is disposed nearest a light engine 202. Additionally, example incoupler 300 has a size 348 (e.g., diameter) larger than that of an exit pupil 224 formed by the light engine 202 providing display light 218 to the example incoupler 300. As an example, within FIG. 3, the outline of an exit pupil 224 formed by the light engine 202 is represented as outline 330 which has a smaller size (e.g., diameter) than the size 348 of the example incoupler 300. In some embodiments, example incoupler 300 includes a diameter equal to or greater than 4.5 mm based on an exit pupil 224 having a diameter of 4 mm. Due to the size 348 of example incoupler 300 being larger than the outline 330 of an exit pupil 224, the exit pupil 224 is less likely to be misaligned with the example incoupler 300 due to any pupil walk from a working distance 226 which reduces the likelihood of vignetting in a resulting FOV. In this way, example incoupler 300 is configured to increase the amount of power captured for (e.g., a greater portion of the exit pupil) display light 218 associated with field points of a resulting FOV likely to experience vignetting while decreasing the amount of power captured for display light 218 of high-efficiency field points not likely to experience vignetting which decreases vignetting in a resulting FOV.

According to embodiments, example incoupler 300 is arranged such that the second, non-planar surface 334 receives display light 218 from a light engine 202. The example incoupler 300 then directs display light 218 such that display light 218 exits the first surface 332 of the example incoupler 300 along the k-vector 336. Such a k-vector 336, for example, represents a direction toward the body 246 of the lightguide 205. In some embodiments, the shape of incoupler 300 has an axis of symmetry disposed near (e.g., within +/−10 degrees) of the k-vector 336. Additionally, in embodiments, the lightguide 205 includes an aperture 328 (e.g., ghost aperture) having the same shape as the example incoupler 300 but having a larger size (e.g., diameter) than the example incoupler 300. Such an aperture 328, for example, represents a portion of the lightguide 205 formed from a material having 50% or more transparency. For example, the aperture includes an area of the lightguide 205 surrounding an area corresponding to the example incoupler 300 (e.g., surrounding an area equal to the area of example incoupler 300) having 50% or more transparency. This aperture 328, for example, is configured to allow at least a portion of display light 218 not received by the example incoupler 300 into the lightguide 205 so as to help reduce any ghosting in the resulting FOV.

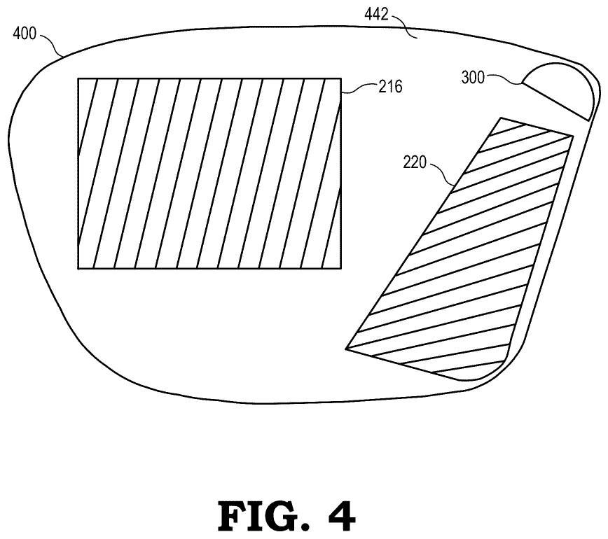

Referring now to FIG. 4, an example lightguide 400 including an incoupler configured for working distance compensation is presented, in accordance with some embodiments. According to embodiments, example lightguide 400 is implemented in projection system 200 as the lightguide 205. In embodiments, example lightguide 400 includes example incoupler 300. Within example lightguide 400, example incoupler 300 is arranged so as to receive display light 218 emitted from a light engine 202 at the second, non-planar surface 334 of the example incoupler 300. The example incoupler 300 then directs the display light 218 out of the first surface 332 of the example incoupler 300 such that the display light 218 propagates via TIR, PIR, or both through the body 442 of the example lightguide 400. According to embodiments, after being directed by the example incoupler 300, the display light 218 is then received by an EPE 220 which splits the display light 218 so as to increase the eyebox of a resulting image. From the EPE 220, the display light 218 propagates through a second portion of the body 442 of the example lightguide 400 and is received by the outcoupler 216. The outcoupler 216 then directs the display light 218 out of the example lightguide 400 and toward the eye 222 of a user.

In some embodiments, certain aspects of the techniques described above may be implemented by one or more processors of a processing system executing software. The software comprises one or more sets of executable instructions stored or otherwise tangibly embodied on a non-transitory computer-readable storage medium. The software can include the instructions and certain data that, when executed by the one or more processors, manipulate the one or more processors to perform one or more aspects of the techniques described above. The non-transitory computer-readable storage medium can include, for example, a magnetic or optical disk storage device, solid-state storage devices such as Flash memory, a cache, random access memory (RAM), or other non-volatile memory device or devices, and the like. The executable instructions stored on the non-transitory computer-readable storage medium may be in source code, assembly language code, object code, or another instruction format that is interpreted or otherwise executable by one or more processors.

A computer-readable storage medium may include any storage medium, or combination of storage media, accessible by a computer system during use to provide instructions and/or data to the computer system. Such storage media can include but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer-readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory) or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is set forth in the claims below.

What is claimed is:

1. A lightguide, comprising:
an incoupler configured to direct display light emitted by a light engine into a body of the lightguide, wherein the incoupler comprises:
a non-planar surface arranged to receive the display light from the light engine; and
a planar surface arranged such that the display light exits the planar surface; and
an outcoupler configured to direct the light out of the lightguide.

2. The lightguide of claim 1, wherein the incoupler comprises a D-shape.

3. The lightguide of claim 1, wherein the incoupler has a diameter greater than an exit pupil formed by the light engine.

4. The lightguide of claim 3, wherein the incoupler has a diameter equal to or greater than 4.5 mm.

5. The lightguide of claim 1, wherein the lightguide further include an aperture having a same shape as the incoupler and a larger size than the incoupler.

6. A display, comprising:
a light engine configured to emit display light and configured to form an exit pupil; and
a lightguide including an incoupler configured to direct the display light into a body of the lightguide, wherein the incoupler includes:
a first surface;
a second, non-planar surface facing the light engine; and
a diameter larger than the exit pupil.

7. The display of claim 6, wherein the lightguide includes a turning prism.

8. The display of claim 6, wherein the diameter of the incoupler is based on a working distance of the lightguide.

9. The display of claim 6, wherein the first surface comprises a curved surface having a radius equal to or greater than 2.5 mm.

10. The display of claim 6, wherein the lightguide includes one or more polarization films.

11. A method of operating the display of claim 6, comprising:
emitting the display light from the light engine;
directing the display light from the light engine into the body of the lightguide; and
propagating the display light through the body of the lightguide.
